(19) United States
(12) Patent Application Publication
(10) Pub. No.: US 2016/0229465 A1
(43) Pub. Date: Aug. 11, 2016

(54) STRUCTURAL MEMBER AND METHOD FOR MANUFACTURING STRUCTURAL MEMBER

(71) Applicant: KABUSHIKI KAISHA KOBE SEIKO SHO (KOBE STEEL, LTD.), Kobe-shi (JP)

(72) Inventors: Takashi GOTO, Fujisawa-shi (JP); Yoshihaya IMAMURA, Fujisawa-shi (JP)

(73) Assignee: KABUSHIKI KAISHA KOBE SEIKO SHO (KOBE STEEL, LTD.), Kobe-shi, Hyogo (JP)

(21) Appl. No.: 15/023,509

(22) PCT Filed: Nov. 17, 2014
(86) PCT No.: PCT/JP2014/080396

§ 371 Date: Mar. 21, 2016

(30) Foreign Application Priority Data
Nov. 26, 2013 (JP) 2013-243733
May 21, 2014 (JP) 2014-105142

(51) Int. Cl. B62D 29/00; B62D 65/02; B62D 27/02; B62D 21/00

(52) U.S. Cl. CPC B62D 29/008; B62D 21/00; B62D 65/02; B62D 27/023; B60Y 2304/05; B60Y 2304/07

(57) ABSTRACT

A structural member includes a cylindrical main body member and at least one nonmagnetic bracket member which includes a cylindrical section and plate-shape sections protruding from the outer peripheral surface of the cylindrical section. The main body member is inserted into the cylindrical section of the bracket member, a gap is formed between the outer surface of the main body member and the inner surface of the cylindrical section in the root portion of a rib on the bracket member, and the entire circumference of the bracket member is electromagnetically contracted to fasten the structural member by swaging.

### TECHNICAL FIELD

The present invention relates to a structural member and a method for manufacturing a structural member.

### BACKGROUND ART

Existing structures, such as a motor vehicle and an architectural structure, are formed from a plurality of strength members, such as a side frame. In such structures, to dispose the members with a predetermined spacing therebetween and increase the strength of the structure, a structural member that connects the members with each other is used. These structural members can be manufactured by pressing a metal plate, assembling members, and fastening the members together using mechanical fastening means, such as welding or bolts.

As a technology related to a structural member, PTL 1, for example, describes a technology related to a vehicle front structure having a reinforce strut tower that bridges between an upper side frame and a front side frame, works with a strut tower, and extends in the vertical direction. In addition, PTL 2 describes a technology related to a vehicle body structure having an inclined lower member that and extends from the front end portion of an upper member to the upper front end portion of a front side frame.

In addition, in recent years, a demand for the designability of the structure has been increasing. Thus, in most cases, the structural member is disposed in a narrow space to efficiently use the space. In such a case, the structural member needs to have a shape that does not interfere with a structure disposed between structural members and other members. If a member that constitutes the structural member is formed by pressing, there may be difficulty forming the member into a predetermined shape with high accuracy, since the structural member is disposed in a narrow space. In addition, the sufficient strength of the structural member may not be available. Furthermore, connection of a bracket portion with the main body portion using welding causes deformation of the structural member due to the welding heat and, thus, decreases the mounting accuracy of the member.

In contrast, in order to form a structural member into a predetermined shape in high accuracy to obtain a strength higher than or equal to a predetermined strength and prevent deformation due to the welding heat, a technology of fastening the members that constitute the structural member together by swaging using electromagnetic tube compression forming is employed.

For example, PTL 3 describes a vehicle frame related technology of fitting a second hollow member into a first hollow member and swaging the overlapping portions by electromagnetic forming. In addition, PTL 4 describes a drive shaft related technology of press-joining two parts to bond them by electric current induction using an electromagnetic forming apparatus. These technologies allow the main body of a tubular member and a bracket to be swaged by making a dent throughout the circumference of a tubular member or compressing the entire periphery of a tubular portion using a magnetic field shaper.

### CITATION LIST

### Patent Literature

PTL 1: Japanese Unexamined Patent Application Publication No. 2004-106704

PTL 2: Japanese Unexamined Patent Application Publication No. 2009-184424

PTL 3: Japanese Unexamined Patent Application Publication No. 2000-264246

PTL 4: Japanese Unexamined Patent Application Publication No. 2007-520353

### SUMMARY OF INVENTION

### Technical Problem

The above technology in PTL 3 describes swaging of tubular members by electromagnetic tube compression. However, to join the cylindrical member to a different member, a bracket member needs to be additionally joined to the cylindrical member using, for example, welding. In addition, according to the technology described in PTL 4, an end portion member is separately formed in addition to a cylindrical swaging member. Accordingly, such a configuration separately having a bracket portion and a swaging portion increases the volume of a member and, in addition, increases the complexity thereof. Accordingly, production using a cast metal milling process or a welding process is needed. Thus, the manufacturing efficiency is reduced, and the manufacturing cost is increased. That is, there has been a demand to easily produce a structural member with high accuracy using these technologies.

Accordingly, it is an object of the present invention to provide a structural member capable of being easily produced with high accuracy and a production method for manufacturing the structural member.

### Solution to Problem

To solve such issues, the present invention is achieved as a result of further study of the present inventors. The present invention provides a structural member including a tubular main body member and at least one bracket member formed from a non-magnetic body, where the bracket member includes a tubular portion and a rib portion formed so as to protrude from the outer peripheral surface of the tubular portion. The main body member is inserted into the tubular portion of the bracket member, and the entire periphery of the bracket member is swaged to a reduced diameter by electromagnetic tube compression to be fastened onto the main body member so that a gap is formed between the inner surface of the tubular portion at a base portion of the rib portion of the bracket member and the outer surface of the main body member.

During the electromagnetic tube compression, the magnetic field shaper is disposed around an area where the tubular main body member overlaps the bracket member having the tubular portion, and magnetic fluxes are generated. Thus, an electromagnetic force generated by an induction current is exerted on the bracket member, and the diameter of the bracket, member is reduced. In this manner, the bracket member and the main body member are swaged and fastened together.

The structural member can be achieved by placing the bracket member at a predetermined position and performing an electromagnetic tube compression process, without using a complicated process.

In addition, since the need for providing the tubular portion having a rib with an extended tubular portion having no rib on the outer surface thereof in order to perform swaging is eliminated, the whole body of the bracket member can be made compact.

In addition, the structural member has the rib portion that protrudes from the outer peripheral surface of the tubular portion of the bracket having the tubular portion. Since the rigidity of the base portion of the rib portion which is part of the tubular portion is high, a portion of the tubular portion other than a rib base portion is mainly swaged and fastened in a direction of radial deformation.

In this manner, the diameter of a portion of the tubular portion other than the base portion of the rib portion is sufficiently reduced, and the amount, of radial deformation of the base portion is smaller than that of the other portion. Accordingly, due to the difference between the amounts of radial deformation of the portions, a protrusion is formed in an area of the main body member that is in contact with the inner peripheral surface of the base portion of the rib portion of the tubular portion and, thus, the load bearing capacity of the structural member in the rotational direction can be improved.

Note that as used herein, the term “amount of radial deformation” refers to the amount of reduction in size of the tubular member caused by electromagnetic tube compression.

In addition, in the structural member, the main body member may be subjected to a bending process. Furthermore, in the structural member, at least part of the main body member may be subjected to a flattening process. In this manner, even when, for example, an interfering object is present for a member connected to the structural member, the structural member can be disposed so as to stay away from the interfering object by performing a bending process or a flattening process on the main body member. In addition, the non-magnetic material may be an aluminum alloy.

Furthermore, the bracket member may be an extruded material. By using an extruded material as the bracket member, the need for cutting, such as milling, can be eliminated.

In addition, the present invention provides a structural member including frame members each formed from a non-magnetic body including a tubular portion and a rib portion formed so as to protrude from the outer peripheral surface of the tubular portion and a frame connecting member that connects the frame members to each other. At least part of the frame connecting member is inserted into the frame member, and the frame member and the frame connecting member are swaged to a reduced diameter and are fastened together by electromagnetic tube compression so that a gap is formed between the inner surface of the tubular portion at a base portion of the rib portion of the frame member and the outer surface of the frame connecting member.

Furthermore, the non-magnetic body may be made of an aluminum alloy.

In addition, the present invention provides a method for manufacturing a structural member including the step of inserting an inner member into a tubular member with a rib, where the tubular member with a rib includes a tubular portion and a rib portion that protrudes from the outer peripheral surface of the tubular portion, the step of disposing a magnetic field shaper so that the magnetic field shaper surrounds the tubular member with a rib, where the magnetic field shaper has a cavity that extends along the outer periphery of the tubular member with a rib and concentrates magnetic fluxes generated by a coil conductor, and the step of swaging and fastening the tubular member with a rib onto the inner member by electromagnetic tube compression by passing an electrical current through the coil conductor.

The method for manufacturing a structural member does not require a complicated process. Electromagnetic tube compression can be performed with a bracket member fixed at a predetermined position, where the bracket member has a particular shape and includes a plate portion. In addition, unlike in the case of a fastening process by welding, the structural member can be achieved without the occurrence of thermal strain.

Part of the magnetic field shaper may be formed so as to protrude from a portion in which the coil conductor is wound around the outer periphery in the axial direction, and the protruding part of the magnetic field shaper may surround the rib portion of the tubular member with a rib. In this manner, even when the rib portion of the tubular member with a rib is large in size, the size of the coil conductor (the diameter of the winding of the coil conductor) need not be increased in accordance with the size of extended part of the rib portion. Accordingly, by replacing the magnetic field shaper with a new one with the winding diameter size of the conductor being fixed, a tubular member with a rib having a rib portion of a variety of shapes and sizes can be formed by electromagnetic tube compression.

According to the method for manufacturing a structural member, the tubular member with a rib may be subjected to a softening process before the swaging and fastening step. In this manner, the amount of radial deformation when performing the electromagnetic tube compression increases and, thus, the swaging force can be increased more.

In addition, according to the method for manufacturing a structural member, an artificial aging process may be performed on the structural member after the swaging and fastening step. In this manner, the strength of the whole structural member can be increased more.

### Advantageous Effects of Invention

According to the present invention, a structural member capable of being easily produced with high accuracy and a method for manufacturing the structural member can be provided.

### BRIEF DESCRIPTION OF DRAWINGS

FIG. 1 is a side view of the vehicle front structure of a motor vehicle to which a structural member according to a first embodiment of the present invention is applied.

FIG. 2 is a perspective view illustrating the structure of the structural member according to the first embodiment.

FIG. 3A illustrates a bracket member joined to a main body member in the structural member according to the first embodiment and illustrates the bracket member and the main body joined together.

FIG. 3B illustrates a bracket, member joined to a main body member in the structural member according to the first embodiment and illustrates the bracket member and the main body joined together.

FIG. 4A illustrates the configuration of an electromagnetic tube compression apparatus for manufacturing the structural member according to the first embodiment and is a side view of the electromagnetic tube compression apparatus.

FIG. 4B illustrates the configuration of an electromagnetic tube compression apparatus for manufacturing the structural member according to the first embodiment and is a front view of the electromagnetic tube compression apparatus.

FIG. 5A illustrates the configuration of a different electromagnetic tube compression apparatus for manufacturing the structural member according to the first embodiment and is a side view of the electromagnetic tube compression apparatus.

FIG. 5B illustrates the configuration of the different electromagnetic tube compression apparatus for manufacturing the structural member according to the first embodiment and is a front view of the electromagnetic tube compression apparatus.

FIG. 6 is a flowchart of the manufacturing process of the structural member according to the first embodiment.

FIG. 7A illustrates the structure of a structural member according to a second embodiment of the present invention.

FIG. 7B illustrates the structure of a structural member according to the second embodiment of the present invention.

FIG. 8 illustrates the structure of a structural member according to a third embodiment of the present invention.

FIG. 9 illustrates the structure of a structural member according to a fourth embodiment of the present invention.

FIG. 10 is a cross-sectional view of the structural member taken along a line X-X of FIG. 9.

FIG. 11 is a cross-sectional view of the structural member taken along a line XI-XI of FIG. 9.

FIG. 12 is a cross-sectional view of a structural member according to a first modification of the fourth embodiment.

FIG. 13 is a cross-sectional view of a structural member according to a second modification of the fourth embodiment.

### DESCRIPTION OF EMBODIMENTS

Embodiments of the present invention are described in detail below. Note that the present invention is not limited to the embodiments described below.

### First Embodiment

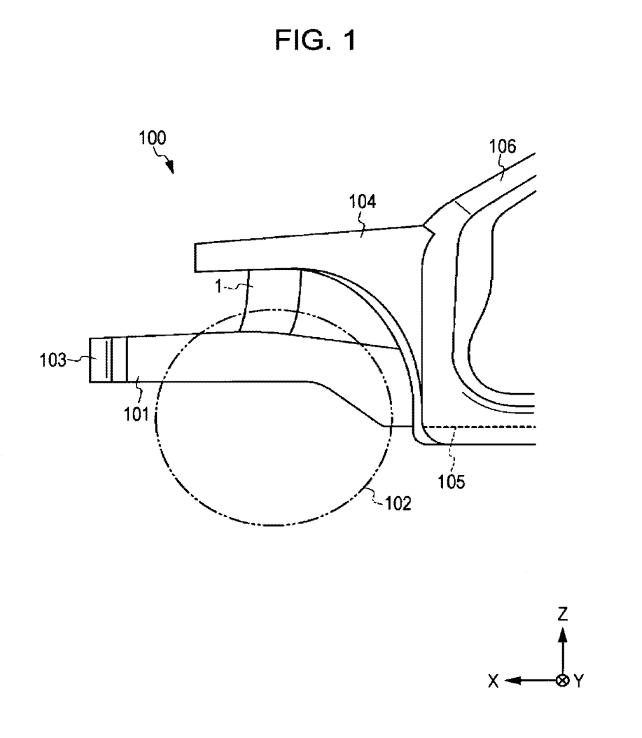

A structural member 1 according to a first embodiment of the present invention is described first. FIG. 1 is a side view of the vehicle front structure of a motor vehicle to which the structural member 1 according to the first embodiment of the present invention is applied. Hereinafter, the case in which the structural member 1 according to the present embodiment is applied to a vehicle front structure 100 of a motor vehicle as a connecting member is described.

Note that in the following description, the direction of forward movement of the motor vehicle (a positive X-axis direction in FIG. 1) is “frontward”. The direction of backward movement (a negative X-axis direction in FIG. 1) is “rearward”. The horizontal direction perpendicular to the forward-backward directions of the motor vehicle (a positive Y-axis direction and a negative Y-axis direction) is a “right-left direction”. In addition, in FIG. 1, a positive Z-axis direction represents the upward side of the motor vehicle, and a negative Z-axis direction represents the downward side of the motor vehicle.

As illustrated in FIG. 1, the vehicle front structure 100 that forms an engine room located in a vehicle front section of the motor vehicle includes front side frames 101 provided on either side of the vehicle front section in the right-left direction, a front bumper beam 103 that bridges between the front end portions of the right and left front side frames 101 (the front side frame located on the back side of the plane of FIG. 1 (in the negative Y-axis direction) is not illustrated), and upper side frames 104 disposed on the outside of the right and left front side frames 101. Note that a reference numeral 102 designates a tire of the motor vehicle.

The front side frame 101 is disposed so as to extend in the front-rear direction of the vehicle body. The rear end of the front side frame 101 is connected to a front floor frame 105 that is disposed under the compartment of the vehicle so as to extend in the front-rear direction of the vehicle body. In addition, the upper side frame 104 is disposed so as to extend from an A-pillar 106 in the frontward direction of the vehicle body. The A-pillar 106 constitutes the front end of a door opening portion of the compartment. The structural member 1 according to the present embodiment connects the front side frame 101 to the upper side frame 104.

### (Structural Member 1)

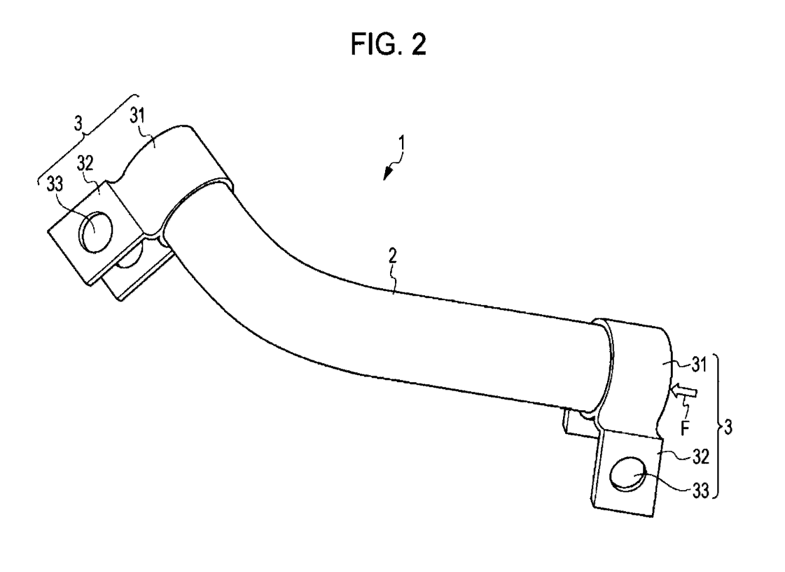

The structure of the structural member 1 according to the present embodiment is described next with reference to FIG. 2. FIG. 2 is a diagram illustrating the structure of the structural member 1 according to the present embodiment.

The structural member 1 according to the present embodiment includes a cylindrical main body member 2 and bracket members 3 joined to either end of the main body member 2 by electromagnetic tube compression.

Note that while description is given with reference to an example in which the bracket members 3 joined to either end of the main body member 2, the structure is not limited to such an example. The structural member 1 according to the present embodiment can employ any structure in which at least one bracket member 3 is joined to the main body member 2. A structure in which one bracket member 3 is joined to one of the ends of the cylindrical main body member 2 can be employed.

Alternatively, although not illustrated, the main body member 2 may have a tubular member that branches therefrom. By joining the bracket member 3 to the tubular member, a structure in which three or more bracket members 3 are joined to the main body member 2 can be employed.

The bracket member 3 includes a tubular portion 31 and a rib portion 32 that is formed so as to protrude from the outer peripheral surface of the tubular portion 31. The bracket member 3 is fastened to the main body member 2 by swaging using electromagnetic tube compression. In addition, the rib portion 32 may have a bolt hole 33 that allows a bolt to pass therethrough, where the bolt is used to attach the rib portion 32 to another structural member (e.g., the front side frame 101 or the upper side frame 104 illustrated in FIG. 1) joined to the structural member 1. In addition, the rib portion 32 may be formed as, but not limited to, a plate portion that protrudes from the outer peripheral surface of the tubular portion 31, as illustrated in FIG. 2.

Note that while the present embodiment has been described with reference to the example in which the main body member 2 and the tubular portion 31 of the bracket member 3 are cylindrical, the present embodiment is not limited to such an example. For example, the main body member 2 and the tubular portion 31 may have a cross section of an ellipse or a substantially rectangle.

The main body member 2 of the structural member 1 according to the present embodiment is formed of, but not limited to, an aluminum alloy or a steel. In addition, the bracket member 3 is formed of a non-magnetic body. In particular, to reduce the weight, and increase the strength, it is desirable that the bracket member 3 be formed of an aluminum alloy. More specifically, an AA2000, AA6000, or AA7000 series aluminum alloy can be suitably used.

In addition, to form the tubular portion 31 and the rib portion 32 of the bracket member 3 at the same time without cutting, such as milling, it is desirable that the bracket member 3 be an extruded material.

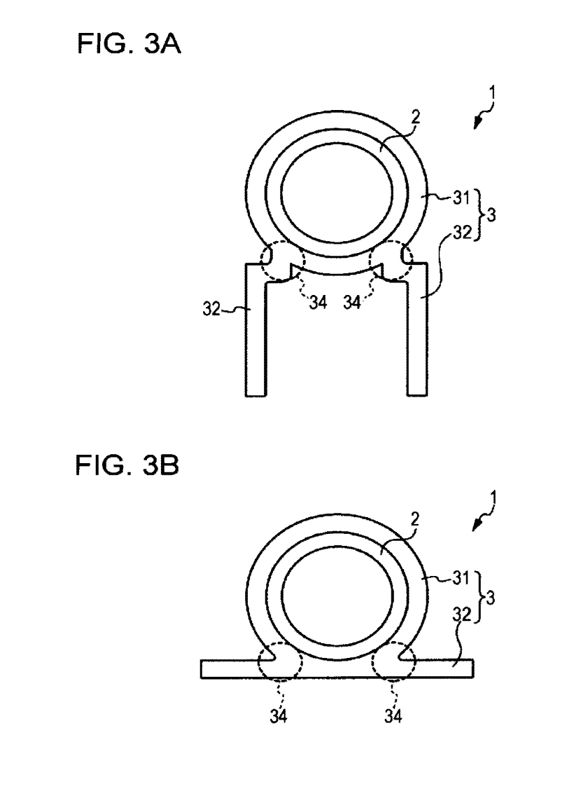

The structure of the bracket member 3 is described in more below with reference to FIGS. 3A and 3B. FIGS. 3A and 3B illustrate the bracket member 3 joined to the main body member 2 viewed in a direction of arrow F in FIG. 2 in the structural member 1 according to the present embodiment. More specifically, FIG. 3A illustrates the bracket member 3a joined to the main body member 2, and FIG. 3B illustrates a bracket member 3b that has a shape which differs from the shape of the bracket member 3a and that is joined to the main body member 2.

According to the structural member 1 of the present embodiment, the configuration of the rib portion 32 is not limited to a particular configuration if the configuration allows the plate portion 32 to be attached to the outer peripheral surface of the tubular portion 31 of the bracket member 3. For example, the configuration in which two rib portions 32, 32 are arranged in parallel so as top face each other, as illustrated in FIG. 3A, may be employed. Alternatively, the configuration in which the rib portion 32 of a flat plate shape is disposed on the opposite side of the main body member 2, as illustrated in FIG. 3B, may be employed in accordance with, for example, the configuration of another structural member.

As described above, according to the present embodiment, in the bracket member 3 of the structural member 1, the rib portion 32 is provided on the outer peripheral surface of the tubular portion 31. Accordingly, even when the bracket member 3 and the main body member 2 are subjected to electromagnetic tube compression, the amount of radial deformation of a base portion 34 of the rib portion 32 of the tubular portion 31 can be smaller than that of a portion of the tubular portion 31 other than the base portion 34, since the rigidity of the base portion 34 of the rib portion 32 is high.

At that time, a gap is formed between the inner surface of the tubular portion 31 at the base portion 34 of the rib portion 32 of the bracket member 3 and the outer surface of the main body member 2. For example, the radial deformation of the main body member 2 does not uniformly occur in the circumferential direction and, thus, local protrusion is formed in an area of the main body member 2 that is to be in contact with the inner peripheral surface of the tubular portion 31 at the base portion 34. Accordingly, when the load is imposed on the bracket member 3 in the rotational direction, rotation of the main body member 2 in the circumferential direction can be prevented. Note that as used herein, the term “amount, of radial deformation” refers to the amount of reduction in diameter of the tubular portion 31 caused by electromagnetic tube compression.

### (Method for Manufacturing Structural Member 1)

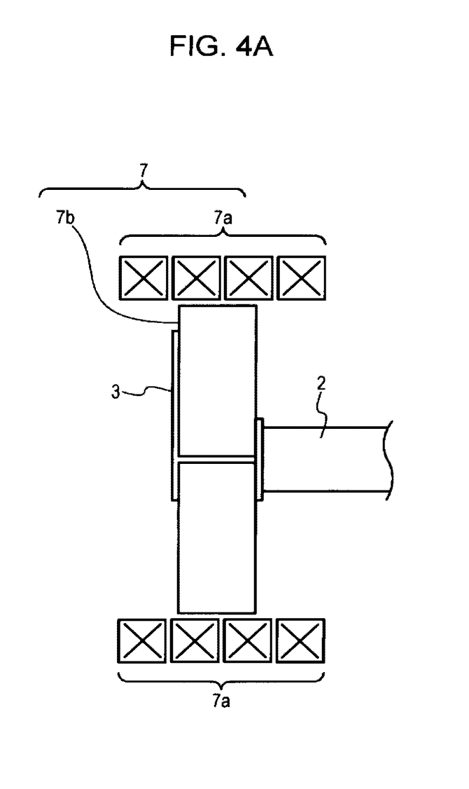

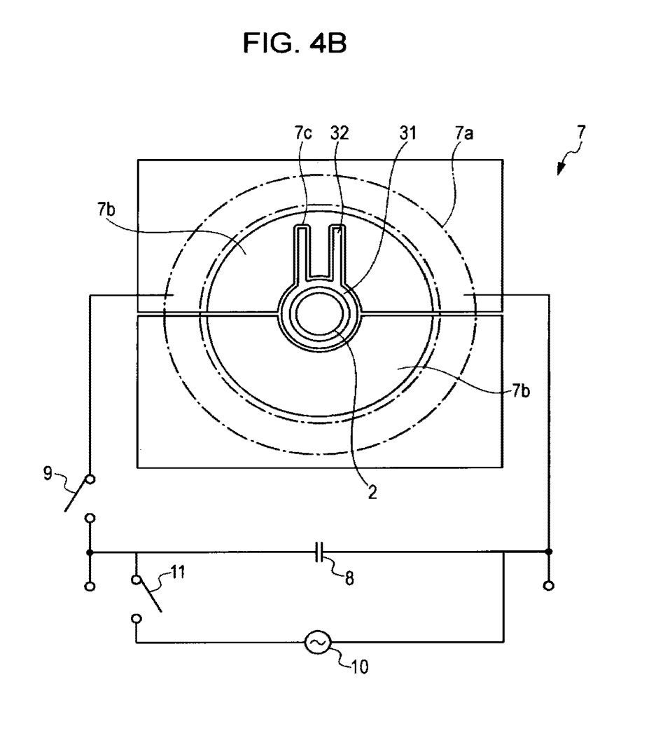

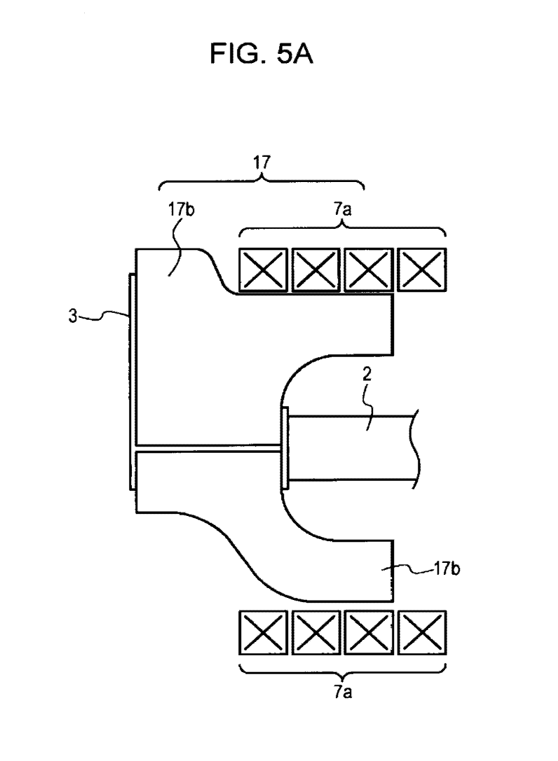

The method for manufacturing the structural member 1 according to the present embodiment is described below with reference to FIGS. 4A, 4B, 5A, 5B, and 6. FIG. 4A illustrates the configuration of an electromagnetic tube compression apparatus 7 for manufacturing the structural member 1 according to the present embodiment and is the side view of the electromagnetic compression apparatus 7. FIG. 4B illustrates the configuration of the electromagnetic tube compression apparatus 7 for manufacturing the structural member 1 according to the present embodiment and is a front view of the electromagnetic tube compression apparatus 7. In addition, FIG. 5A illustrates the configuration of another electromagnetic tube compression apparatus 17 for manufacturing the structural member 1 according to the present embodiment and is a side view of the electromagnetic tube compression apparatus 17. FIG. 5B illustrates the configuration of the electromagnetic tube compression apparatus 17 for manufacturing the structural member 1 according to the present embodiment and is a front view of the electromagnetic tube compression apparatus 17. FIG. 6 is a flowchart of the manufacturing process of the structural member 1 according to the present embodiment.

The method for manufacturing the structural member 1 using the electromagnetic tube compression apparatus 7 illustrated in FIGS. 4A and 4B is described first. One of the ends of the main body member (an inner member) 2 is inserted into the tubular portion 31 of one of the bracket members (a tubular members with a rib) 3, and the other end is inserted into the tubular portion 31 of the other bracket member 3 (step S11 in FIG. 6) first. Subsequently, as illustrated in FIGS. 4A and 4B, each of the bracket members 3 having the main body member 2 inserted thereinto is surrounded by a magnetic field shaper 7b of the electromagnetic tube compression apparatus 7 (step S12 in FIG. 6). More specifically, it is desirable that the bracket member 3 be inserted into a cavity 7c of the magnetic field shaper 7b that has substantially the same shape as the bracket member 3 and that extends along the bracket member 3.

The magnetic field shaper 7b is separated into two portions, that is, upper and lower portions. A coil conductor 7a is disposed on the outer periphery of the magnetic field shaper 7b. In addition, the magnetic field shaper 7b can concentrate magnetic fluxes generated by the coil conductor 7a.

Subsequently, if a switch 9 is turned on to allow an electric current to pass through, a capacitor 8 discharges an electric current (step S13 in FIG. 6). In this manner, a large electric current instantaneously flows in the coil conductor 7a. The magnetic fluxes generated by the coil conductor 7a concentrate on a surface that faces the outer peripheral surface of the tubular portion 31 of the bracket member 3 disposed in the magnetic field shaper 7b.

As a result, an induction current is generated in the bracket member 3, which is a non-magnetic body. Due to the mutual influence between the induction current and the electromagnetic field, a force (an electromagnetic force) that compresses a portion in which the main body member 2 overlaps the tubular portion 31 is generated. In this manner, the bracket member 3 and the main body member 2 are fastened together by swaging. Note that in FIG. 4B, a reference numeral 10 designates a power supply for a charging circuit, and a reference numeral 11 designates a charging switch.

At that time, since the base portion 34, which is part of the tubular portion 31, has a high rigidity, the amount of radial deformation of the base portion 34 may be smaller than that of a portion other than the base portion 34 of the tubular portion 31. Accordingly, the main body member 2 is nonuniformly radially deformed in the circumferential direction and is fastened by swaging and, thus, local protrusion is formed in an area in which the main body member 2 is to be in contact with the inner periphery surface of the tubular portion 31 at the base portion to which the rib portion 32 is connected. Thus, rotation of the bracket member 3 with respect to the main body member 2 in the circumferential direction is prevented and, therefore, the bracket member 3 can be prevented from being pulled all the way from the main body member 2 due to insufficient swaging of the bracket member 3 and the main body member 2.

Note that at least part of a portion of the tubular portion 31 of the bracket member 3 other than the base portion (also referred to as “connecting portion”) 34 may have a thin-wall portion (not illustrated). The thin-wall portion has a thickness between the inner periphery and the outer periphery that is smaller than the thickness of the other portion. In this manner, the difference between the amounts of radial deformation in the circumferential direction can be increased more. Accordingly, rotation of the bracket member 3 with respect to the main body member 2 in the circumferential direction can be more effectively prevented. In addition, after the bracket member 3 is swaged to the main body member 2, the bracket member 3 may be partially welded to the main body member 2 by spot welding or MIG spot welding or may be partially joined to the main body member 2 by friction stir spot welding. Alternatively, the bracket member 3 may be welded to the main body member 2 by line welding (MIG welding, TIG welding, or laser welding) such that deformation is avoided. Still alternatively, the bracket member 3 may be linearly joined to the main body member 2 by friction stir welding. In this manner, the joint strength between the bracket member 3 and the main body member 2 can be increased more.

In the production method for manufacturing the structural member 1 according to the present embodiment, the electromagnetic tube compression apparatus 17 illustrated in FIGS. 5A and 5B, for example, can be used instead of the electromagnetic tube compression apparatus 7 illustrated in FIGS. 4A and 4B. As illustrated in FIG. 5A, in the electromagnetic tube compression apparatus 17, some portion of the outer periphery of a magnetic field shaper 17b does not have the coil conductor 7a provided thereon. The portion on which the coil conductor 7a is not provided is formed so as to protrude from a portion formed by winding the coil conductor 7a around the outer periphery thereof in the axial direction of the coil (a direction parallel to the center axis of the winding of the conductor). The portion can surround the bracket member 3.

In the electromagnetic tube compression apparatus 7 illustrated in FIGS. 4A and 4B, the coil conductor 7a is disposed around the entire outer periphery of the magnetic field shaper 7b. Thus, the size of the coil conductor 7a needs to be increased with increasing size of the rib portion 32 of the bracket member 3. Accordingly, the manufacturing cost of the coil increases. In contrast, in the electromagnetic tube compression apparatus 17 illustrated in FIGS. 5A and 5B, some portion of the magnetic field shaper 17b protrudes from the area where the winding of the coil conductor 7a is formed, and the protruding portion surrounds the bracket member 3. Accordingly, even when the rib portion 32 having a large size is employed, the size of the coil conductor 7a need not be increased. As a result, by using the electromagnetic tube compression apparatus 17, the manufacturing cost of the coil can be reduced.

In addition, it is desirable that the bracket member 3 be subjected to a softening process using, for example, annealing or quenching. By performing the softening process on the bracket member 3, the amount of radial deformation after the electromagnetic tube compression increases and, thus, the swaging force of the bracket member 3 against the main body member 2 can be increased.

The structural member 1 may be formed by electromagnetic tube compression after quenching as needed and, thereafter, an artificial aging process may be performed. In this manner, the strength of the bracket member 3 can be increased more. At that time, it is desirable that the bracket member 3 be formed of 2000, 6000, or 7000 series aluminum alloy.

As described in detail above, according to the structural member 1 of the present embodiment, electromagnetic tube compression is performed with the bracket member 3 fixed at predetermined position. Accordingly, a complicated process that is required for welding is not necessary and, thus, the structural member 1 can be easily achieved with high accuracy. In particular, thermal strain which occurs when the main body member 2 and the bracket member 3 are fastened together by welding does not occur and, thus, the structural member 1 with high accuracy can be achieved. In addition, since the rib portion 32 is disposed on the outer surface of the tubular portion 31, the bracket member 3 can be compact.

Furthermore, the bracket member 3 and the main body member 2 are fastened together by swaging using electromagnetic tube compression. Thus, the amount of radial deformation of a portion of the tubular portion 31 other than the connecting portion 34 between the tubular portion 31 and the rib portion 32 may be larger than that of the connecting portion 34. In this manner, the main body member 2 is not uniformly radially deformed in the circumferential direction. Thus, a protrusion is formed in an area to be in contact with the inner peripheral surface of the connecting portion 34. Accordingly, rotation of the bracket member 3 with respect to the main body member 2 can be prevented. That is, the load bearing against the load imposed on the structural member 1 in the circumferential direction can be improved and, thus, the structural member 1 having improved strength can be achieved.

### Second Embodiment

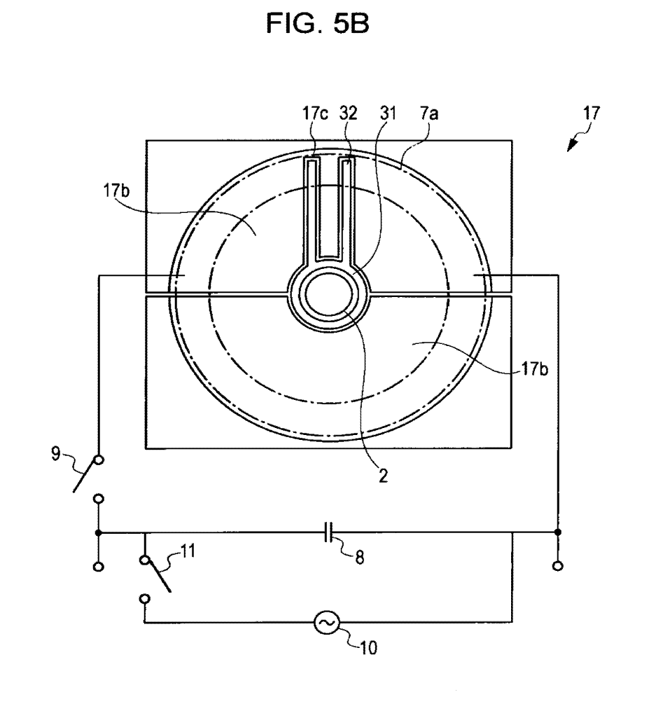

A structural member 12 according to a second embodiment of the present invention is described below. FIGS. 7A and 7B illustrate the structure of the structural member 12 according to the second embodiment of the present invention.

The structural member 12 according to the present embodiment differs from the above-described structural member 1 according to the first embodiment of the present invention in only that a main body member is subjected to a bending process. Thus, according to the present embodiment, only a main body member 22 of the structural member 12 is described below.

As illustrated in FIGS. 7A and 7B, according to the structural member 12 of the present embodiment, part of the main body member 22 is subjected to a bending process (refer to a reference symbol “A” in FIG. 7B). Accordingly, even when an interfering object 6 is present between connected objects 4 and 5 that are connected to each other by the structural member 12, the structural member 12 can be stably disposed.

Note that in FIGS. 7A and 7B, only one portion A is subjected to a bending process. However, a plurality of bending portions may be provided in accordance with the size and shape of the interfering object 6.

As described in detail above, according to the structural member 12 of the present embodiment, part of the main body member 22 is subjected to a bending process. Accordingly, the structural member 12 can be disposed so as to stay away from the interfering object. Thus, the flexibility of the design of the structure including the structural member 12 can be increased.

### Third Embodiment

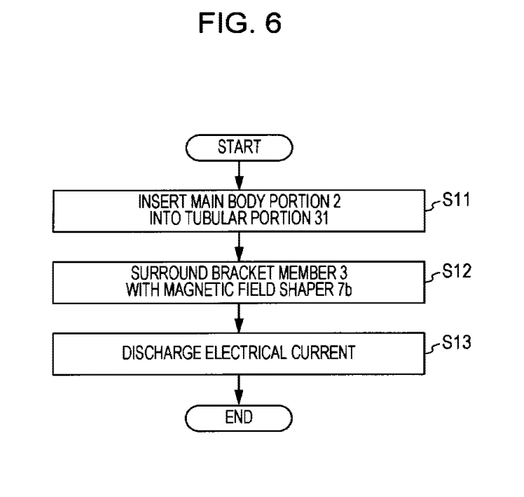

A structural member 13 according to a third embodiment of the present invention is described below. FIG. 8 illustrates the configuration of the structural member 13 according to the third embodiment of the present invention.

The structural member 13 according to the present embodiment differs from the above-described structural member 1 according to the first embodiment, of the present invention in only that a main body member is subjected to a flattening process. Thus, according to the present embodiment, only a main body member 23 of the structural member 13 is described below.

As illustrated in FIG. 8, according to the structural member 13 of the present embodiment, part of the main body member 23 (the middle portion) is subjected to a flattening process (refer to a reference symbol “B” in FIG. 8). Accordingly, even when an interfering object 6 is present between connected objects 4 and 5 (refer to FIGS. 7A and 7B) that are connected to each other by the structural member 13, the structural member 13 can be disposed.

Note that in FIG. 8, only one portion B is subjected to a flattening process. However, a plurality of flat portions may be provided in accordance with the size and shape of the interfering object 6. In addition, although not illustrated, a plurality of the above-described bending portions and a plurality of the above-described flat portions may be provided.

As described in detail above, according to the structural member 13 of the present embodiment, part of the main body member 23 is subjected to a flattening process. Accordingly, the structural member 13 can be disposed so as to stay away from the interfering object. Thus, the flexibility of the design of the structure including the structural member 13 can be increased.

### Fourth Embodiment

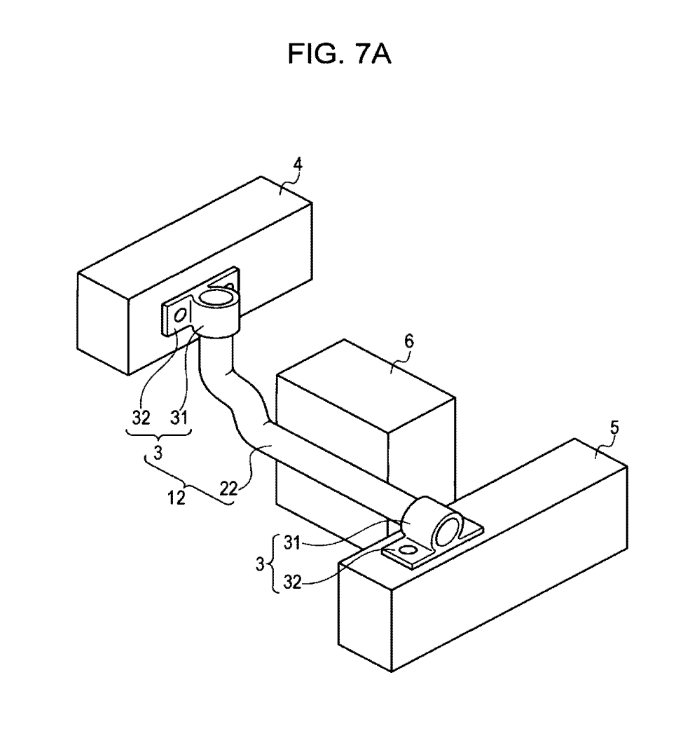

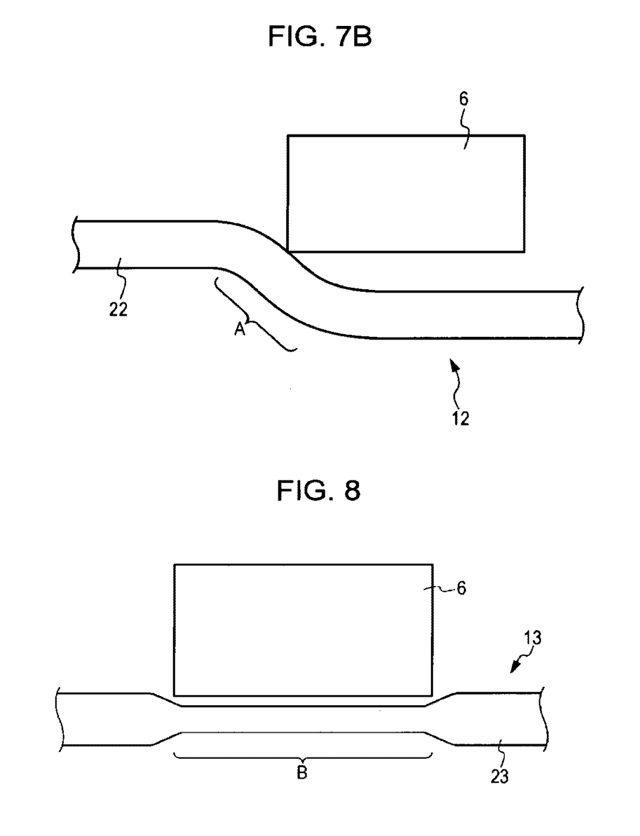

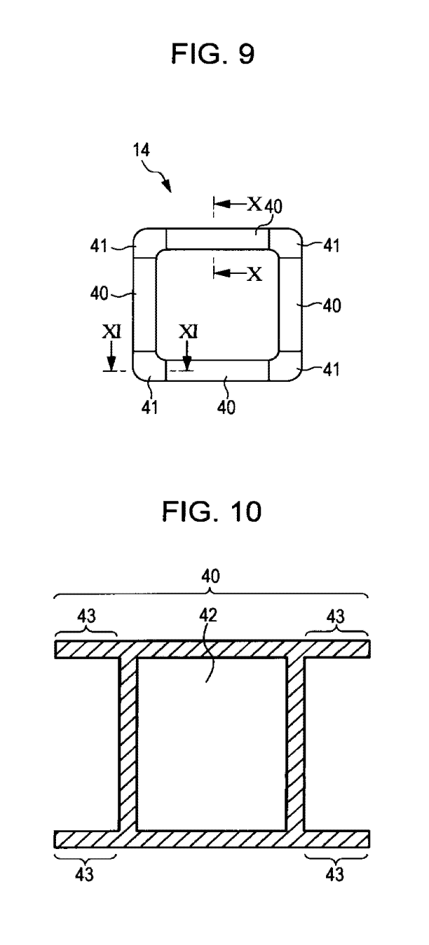

A structural member 14 according to a fourth embodiment of the present invention is described below. FIG. 9 illustrates the structure of the structural member 14 according to the fourth embodiment of the present invention. In addition, FIG. 10 is a cross-sectional view of the structural member 14 taken along a line X-X of FIG. 9, and FIG. 11 is a cross-sectional view of the structural member 14 taken along a line XI-XI of FIG. 9.

The structural member 14 functions as a frame structure. The structural member 14 includes frame members 40 each made from a non-magnetic body and a frame connecting member 41 that connects the frame members 40 to each other. Each of the frame members 40 includes a tubular portion 42 and a rib portion 43 that is formed so as to protrude from the outer peripheral surface of the tubular portion 42. In addition, according to the structural member 14 of the present embodiment, at least part of the frame connecting member 41 is inserted into the frame member 40, and the frame member 40 and the frame connecting member 41 are fastened together by swaging using electromagnetic tube compression. More specifically, the entire peripheries of the frame member 40 and the frame connecting member 41 are swaged to a reduced diameter by electromagnetic tube compression to be fastened together so that so that a gap is formed between the inner surface of the tubular portion 42 at the base portion of the rib portion 43 of the frame member 40 and the outer surface of the frame connecting member 41.

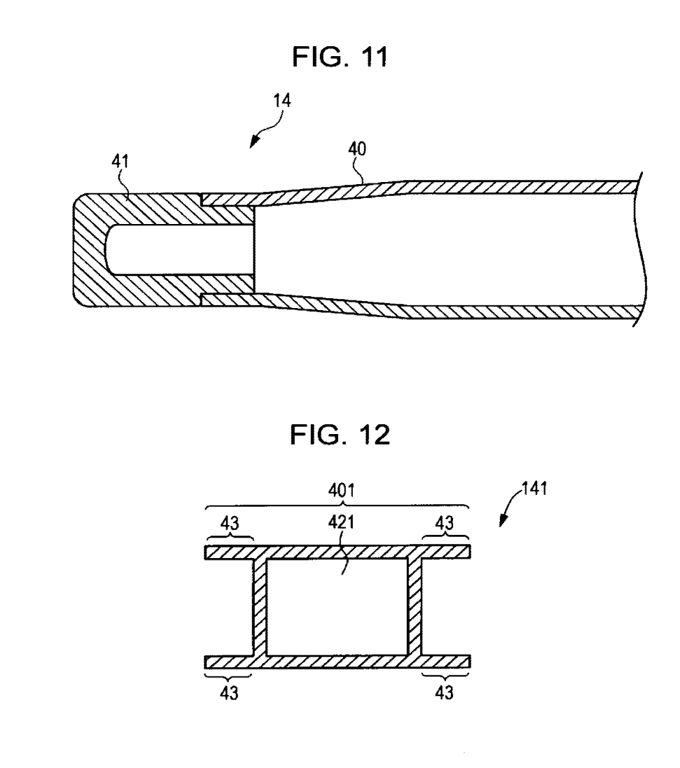

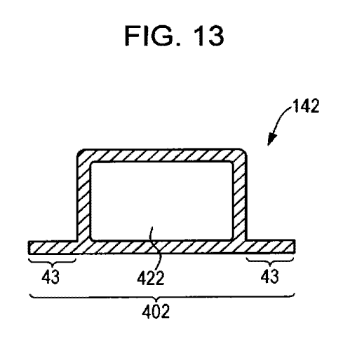

In an example illustrated in FIG. 10, the cross-sectional shape of the tubular portion 42 is a square. However, the shape is not limited to a particular shape. FIG. 12 is a cross-sectional view of a structural member 141 according to a first modification of the present exemplary embodiment. In addition, FIG. 13 is a cross-sectional view of a structural member 142 according to a second modification of the present exemplary embodiment. For example, as illustrated in FIG. 12, the cross-sectional shape of a tubular portion 421 may be rectangle. Alternatively, as illustrated in FIG. 13, the cross-sectional shape of a tubular portion 422 may be a substantially rectangle having the curved corners. Still alternatively, although not illustrated, the cross-sectional shape of the tubular portion 42 may be, for example, a polygon (including a nonaxisymmetric shape).

In addition, in an example illustrated in FIG. 10, the rib portion 43 is formed in each of the four corners of the square cross section of the tubular portion 42. However, the structure is not limited thereto. For example, as illustrated in FIG. 13, the rib portion 43 is formed only in each of two of the four corners of the substantially rectangular cross section of the tubular portion 42.

According to the structural member 14 of the present embodiment, the frame member 40 is formed from a non-magnetic body. In particular, to reduce the weight and increase the strength, it is desirable that the frame member 40 be formed of an aluminum alloy. More specifically, an AA2000, AA6000, or AA7000 series aluminum alloy is suitably used as the aluminum alloy. In addition, the frame connecting member 41 is formed of, but not limited to, an aluminum alloy or a steel. Alternatively, the frame connecting member 41 may be a tubular member or a solid member. In addition, after the frame member 40 and the frame connecting member 41 are swaged together, the frame member 40 may be partially welded to the frame connecting member 41 by spot welding or MIG spot welding or may be partially joined to the frame connecting member 41 by friction stir spot welding. Alternatively, the frame member 40 may be welded to the frame connecting member 41 by line welding (MIG welding, TIG welding, or laser welding) such that deformation is avoided. Still alternatively, the frame member 40 may be linearly joined to the frame connecting member 41 by friction stir welding. In this manner, the joint strength between the frame member 40 and the frame connecting member 41 can be increased more.

According to the structural member 14 of the present embodiment, as described above, the frame member 40 and the frame connecting member 41 are fastened together by swaging using electromagnetic tube compression. Accordingly, a complicated process that is required for welding is not necessary and, thus, the structural member 14 can be easily achieved with high accuracy.

This application claims the benefit of Japanese Patent Application No. 2013-243733 filed Nov. 26, 2013 and No. 2014-105142 filed May 21, 2014, which are hereby incorporated by reference herein in their entirety.

### REFERENCE SIGNS LIST

1, 12, 13, 14, 141, 142 structural member
2, 22, 23 main body member (inner member)
3 bracket member (tubular member with rib)
31, 42 tubular member
32, 43 rib portion
34 base portion
40 frame member (tubular member with rib)
41 frame connecting member (inner member)
7 electromagnetic tube compression apparatus
7a coil conductor
7b magnetic field shaper
7c cavity

1. A structural member comprising:
a tubular main body member; and
at least one bracket member formed from a non-magnetic body, the bracket member including a tubular portion and a rib portion formed so as to protrude from the outer peripheral surface of the tubular portion,
wherein the main body member is inserted into the tubular portion of the bracket member, and the entire periphery of the bracket member is swaged to a reduced diameter by electromagnetic tube compression to be fastened onto the main body member so that a gap is formed between the inner surface of the tubular portion at a base portion of the rib portion of the bracket member and the outer surface of the main body member.

2. The structural member according to claim 1, wherein a protrusion is formed in an area of the main body member that is in contact with the inner peripheral surface of the tubular portion at the base portion of the rib portion.

3. The structural member according to claim 1, wherein the main body member is subjected to a bending process.

4. The structural member according to claim 1, wherein at least part of the main body member is subjected to flattening process.

5. The structural member according to claim 1, wherein the bracket member is made from an extruded material.

6. A structural member comprising:
frame members each formed from a non-magnetic body including a tubular portion and a rib portion formed so as to protrude from the outer peripheral surface of the tubular portion; and
a frame connecting member configured to connect the frame members to each other,
wherein at least part of the frame connecting member is inserted into the frame member, and the frame member and the frame connecting member are swaged to a reduced diameter and are fastened together by electromagnetic tube compression so that a gap is formed between the inner surface of the tubular portion at a base portion of the rib portion of the frame member and the outer surface of the frame connecting member.

7. The structural member according to claim 1, wherein the non-magnetic body is made of an aluminum alloy.

8. A method for manufacturing a structural member, comprising:
inserting an inner member into a tubular member with a rib, the tubular member including a tubular portion and a rib portion that protrudes from the outer peripheral surface of the tubular portion;
disposing a magnetic field shaper so that the magnetic field shaper surrounds the tubular member with a rib, the magnetic field shaper having a cavity that extends along the outer periphery of the tubular member with a rib and concentrating magnetic fluxes generated by a coil conductor; and
swaging and fastening the tubular member with a rib onto the inner member using electromagnetic tube compression by passing an electrical current through the coil conductor.

9. The method for manufacturing a structural member according to claim 8, wherein part of the magnetic field shaper is formed so as to protrude from a portion in which the coil conductor is wound around the outer periphery in the axial direction, and
wherein the protruding part of the magnetic field shaper surrounds the tubular member with a rib.

10. The method for manufacturing a structural member according to claim 8, wherein the tubular member with a rib is subjected to a softening process before the swaging and fastening the tubular member with a rib onto the inner member.
